(19) United States
(12) Patent Application Publication
(10) Pub. No.: US 2019/0263534 A1
(43) Pub. Date: Aug. 29, 2019

(54) CONTROL OF FLIGHT INFORMATION RECORDER OPERATION

(71) Applicant: BOMBARDIER INC., Dorval (CA)

(72) Inventors: Marcio DA SILVA ROCHA, Saint-Laurent (CA); André GAUTHIER, Pointe-Claire (CA)

(21) Appl. No.: 16/349,048

(22) PCT Filed: Nov. 1, 2017
(86) PCT No.: PCT/IB2017/056795

§ 371 Date: May 10, 2019

Related U.S. Application Data
(60) Provisional application No. 62/420,624, filed on Nov. 11, 2016.

(51) Int. Cl. B64D 45/00; G07C 5/08; G07C 5/02

(52) U.S. Cl. CPC B64D 45/00; G07C 5/085; B64D 2045/0085; B64D 2045/0065; G07C 5/02

(57) ABSTRACT

The present disclosure provides methods, systems, and apparatuses for controlling operation of a flight information recorder of an aircraft. A plurality of flight parameters, including a speed parameter, an engine operation parameter, an in-air parameter, and a descent parameter of the aircraft are monitored. When a shutdown condition associated with the flight parameters is satisfied, power to the flight information recorder is removed via an electrical system of the aircraft.

### CROSS-REFERENCE TO RELATED APPLICATION(S)

This International PCT Patent Application relies for priority on U.S. Provisional Patent Application Ser. No. 62/420,624 filed on Nov. 11, 2016, the entire content of which is incorporated herein by reference.

### TECHNICAL FIELD

The present disclosure relates generally to aircraft flight information recorder operation, and more specifically to the shutdown of flight information recorders post-incident.

### BACKGROUND

In order to help determine the possible causes of aircraft incidents, modern aircraft are equipped with one or more flight information recorders. Colloquially referred to as “black boxes”, flight information recorders serve to preserve data relating to the last moments of a flight, in case of an unplanned in-flight event. Typically, an aircraft includes both a flight data recorder, which preserves instrumentation and flight parameters, and a cockpit voice recorder, which preserves recordings of communications between crew members.

The flight information recorder operates in an infinite loop, continually rewriting the oldest information with the newest information as long as the flight information recorder is appropriately powered. In the case of an unplanned in-flight event, power to the flight information recorder is removed and the previously recorded data is saved for later review by the appropriate authorities. In order to remove the power to the flight information recorder, so as to prevent important data from being overwritten, an impact switch, also known as a g-switch, is placed in the electrical path powering the flight information recorder. The impact switch is sensitive to changes in acceleration, and serves to remove power to the flight information recorders and thus stop the recording.

However, impact switches can be unreliable and may fail undetected. This can cause the flight data recorders to continue to loop even after an incident, which can lead to unavailability of flight information recorder data. Additionally, impact switches can be manually tripped, for example during routine maintenance. This, in turn, can require additional maintenance to repair or replace the impact switches.

As such, there is a need for improved control mechanisms for the operation of flight information recorders.

### SUMMARY

The present disclosure provides methods, systems, and apparatuses for controlling operation of a flight information recorder of an aircraft. A plurality of flight parameters, including a speed parameter, an engine operation parameter, an in-air parameter, and a descent parameter of the aircraft are monitored. When a shutdown condition associated with the flight parameters is satisfied, power to the flight information recorder is removed via an electrical system of the aircraft.

In accordance with a broad aspect, there is provided a method for controlling operation of a flight information recorder of an aircraft, comprising: monitoring flight parameters of the aircraft, the flight parameters comprising: a speed parameter; an engine operation parameter; an in-air parameter; and a descent parameter; and when a shutdown condition associated with the flight parameters is satisfied, removing power to the flight information recorder via an electrical system of the aircraft.

In some embodiments, monitoring a descent parameter comprises monitoring a vertical descent parameter, and wherein the shutdown condition is associated at least in part with the vertical descent parameter reaching a descent threshold.

In some embodiments, monitoring a descent parameter comprises monitoring a descent delay, and wherein the shutdown condition is associated at least in part with the descent delay elapsing.

In some embodiments, monitoring the flight parameters comprises monitoring all the flight parameters substantially simultaneously.

In some embodiments, monitoring the flight parameters comprises monitoring the descent parameter separately from the speed, engine operation, and in-air parameters.

In some embodiments, monitoring the flight parameters comprises monitoring the descent parameter upon determination that the speed, engine operation and in-air parameters have satisfied predetermined thresholds.

In some embodiments, monitoring the speed parameter comprises monitoring at least one of an airspeed, a ground speed, and global-positioning-system-based speed of the aircraft.

In some embodiments, monitoring the engine operation parameter comprises monitoring at least one of engine oil pressure, engine fuel flow, turbine rotations-per-minute, and fan rotations-per-minute.

In some embodiments, monitoring the in-air parameter comprises monitoring at least one of a weight-off-wheels parameter and a weight-on-wheels parameter.

In some embodiments, monitoring the in-air parameter comprises monitoring an altitude of the aircraft.

In some embodiments, monitoring the flight parameters comprises obtaining the flight parameters through the electrical system of the aircraft.

In accordance with another broad aspect, there is provided a system for controlling operation of a flight information recorder powered by an electrical system of an aircraft, the system comprising: a processing unit; and a non-transitory memory communicatively coupled to the processing unit and comprising computer-readable program instructions. The computer-readable program instructions are executable by the processing unit for: monitoring flight parameters of the aircraft, the flight parameters comprising: a speed parameter; an engine operation parameter; an in-air parameter; and a descent parameter; and when a shutdown condition associated with the flight conditions is satisfied, removing power to the flight information recorder via the electrical system.

In some embodiments, monitoring a descent parameter comprises monitoring a vertical descent parameter, and wherein the shutdown condition is associated at least in part with the vertical descent parameter reaching a descent threshold.

In some embodiments, monitoring a descent parameter comprises monitoring a descent delay, and wherein the shutdown condition is associated at least in part with the descent delay elapsing.

In some embodiments, monitoring the flight parameters comprises monitoring all the flight parameters substantially simultaneously.

In some embodiments, monitoring the flight parameters comprises monitoring the descent parameter separately from the speed, engine operation, and in-air parameters.

In some embodiments, monitoring the flight parameters comprises monitoring the descent parameter upon determination that the speed, engine operation and in-air parameters have satisfied predetermined thresholds

In some embodiments, monitoring the speed parameter comprises monitoring at least one of an airspeed, a ground speed, and global-positioning-system-based speed of the aircraft.

In some embodiments, monitoring the engine operation parameter comprises monitoring at least one of engine oil pressure, engine fuel flow, turbine rotations-per-minute, and fan rotations-per-minute.

In some embodiments, monitoring the in-air parameter comprises monitoring at least one of a weight-off-wheels parameter and a weight-on-wheels parameter.

In some embodiments, monitoring the in-air parameter comprises monitoring an altitude of the aircraft.

In some embodiments, monitoring the flight parameters comprises obtaining the flight parameters through the electrical system of the aircraft.

In accordance with another broad aspect, there is provided a flight information recorder shutdown apparatus for an aircraft, the apparatus comprising: a power source in an electrical system of the aircraft; a switching device operatively connected between the power source and a power input of a flight information recorder in the aircraft; and emergency stop logic connected to the switching device and configured for: monitoring flight parameters of the aircraft, the flight parameters comprising: a speed condition; an engine operation condition; an in-air condition; and a descent parameter; and when a shutdown condition associated with the flight parameters is satisfied, opening the switching device to remove power to the flight information recorder.

In some embodiments, the switching device is located in the electrical system of the aircraft.

In some embodiments, monitoring a descent parameter comprises monitoring a vertical descent parameter, and wherein the shutdown condition is associated at least in part with the vertical descent parameter reaching a descent threshold.

In some embodiments, monitoring a descent parameter comprises monitoring a descent delay, and wherein the shutdown condition is associated at least in part with the descent delay elapsing.

In some embodiments, monitoring the flight parameters comprises monitoring all the flight parameters substantially simultaneously.

In some embodiments, monitoring the flight parameters comprises monitoring the descent parameter separately from the speed, engine operation, and in-air parameters.

In some embodiments, monitoring the flight parameters comprises monitoring the descent parameter upon determination that the speed, engine operation and in-air parameters have satisfied predetermined thresholds.

In some embodiments, monitoring the speed parameter comprises monitoring at least one of an airspeed, a ground speed, and global-positioning-system-based speed of the aircraft.

In some embodiments, monitoring the engine operation parameter comprises monitoring at least one of engine oil pressure, engine fuel flow, turbine rotations-per-minute, and fan rotations-per-minute.

In some embodiments, monitoring the in-air parameter comprises monitoring at least one of a weight-off-wheels parameter and a weight-on-wheels parameter.

In some embodiments, monitoring the in-air parameter comprises monitoring an altitude of the aircraft.

In some embodiments, monitoring the flight parameters comprises obtaining the flight parameters through the electrical system of the aircraft.

In accordance with another broad aspect, there is provided a method for controlling operation of a flight information recorder of an aircraft, comprising: monitoring flight parameters of the aircraft, the flight parameters comprising: at least one of a ground speed and a global-positioning-system-based speed; at least one of engine fuel flow, turbine rotations-per-minute and fan rotations-per-minute; and at least one of a weight-on-wheels condition, a weight-off-wheels condition and an altitude of the aircraft; and when a shutdown condition associated with the flight parameters is satisfied, removing power to the flight information recorder via an electrical system of the aircraft.

Features of the systems, devices, and methods described herein may be used in various combinations, and may also be used for the system and computer-readable storage medium in various combinations.

### BRIEF DESCRIPTION OF THE DRAWINGS

Further features and advantages of embodiments described herein may become apparent from the following detailed description, taken in combination with the appended drawings, in which:

FIG. 1 is a diagram of an example aircraft.

FIG. 2 is a diagram of a flight information recorder system of the aircraft of FIG. 1, in accordance with an embodiment.

FIG. 3 is flowchart of a method for controlling operation of a flight information recorder in accordance with an embodiment.

FIG. 4 is a schematic diagram of an example computing system for implementing the method of FIG. 3 in accordance with an embodiment.

FIG. 5 is a block diagram of an example implementation of a flight information recorder operation control system.

It will be noted that throughout the appended drawings, like features are identified by like reference numerals.

### DETAILED DESCRIPTION

A mechanism for controlling operation of one or more flight information recorders (FIR) of an aircraft is provided. Flight parameters, namely speed, engine operation, in-air, and descent parameters are monitored. If a shutdown condition associated with the flight parameters is satisfied, this indicates that an unplanned in-flight event has occurred, and power to the flight information recorder is removed via an electrical system of the aircraft. This allows for the information recorded by the FIR to be preserved.

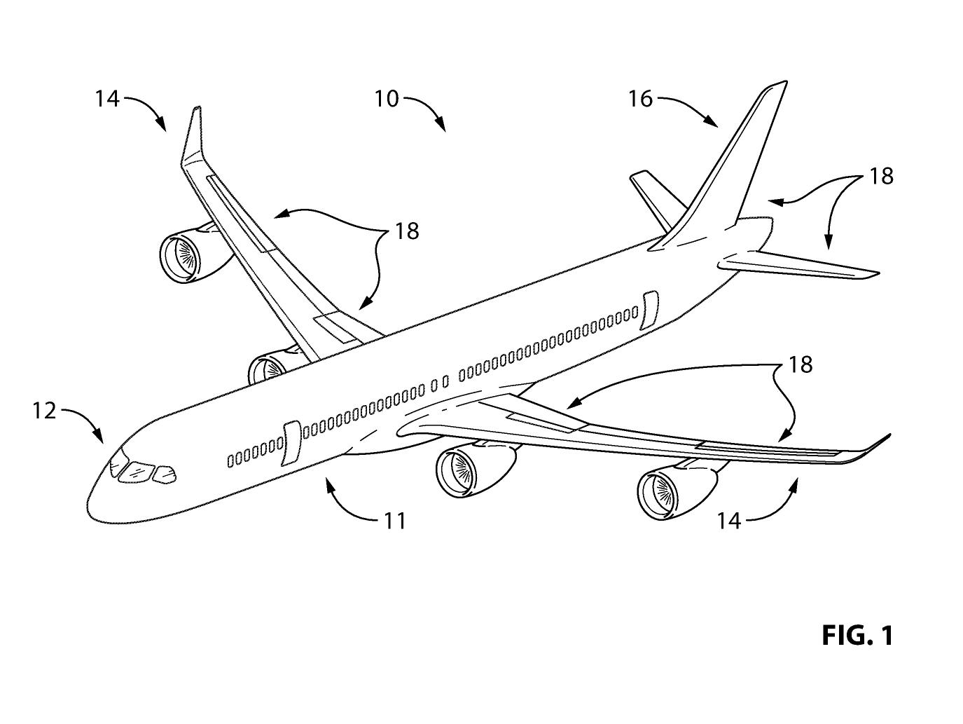

With reference to FIG. 1, an aircraft 10, having a fuselage 11, a pair of wings 14, and a tail 16, is equipped with a cockpit 12 and one or more flight components 18. The aircraft 10 can be any type of aircraft, including propeller planes, jet planes, turbojet planes, turbo-propeller planes, turboshaft planes, gliders, and the like. The cockpit 12 may be positioned at any suitable location on the aircraft 10, for example at a front portion of the fuselage 11. The cockpit 12 is configured for accommodating one or more pilots who control the aircraft 10 by way of one or more operator controls (not illustrated). The operator controls may include any suitable number of pedals, yokes, steering wheels, centre sticks, flight sticks, levers, knobs, switches, and the like.

The flight components 18 can be positioned at any suitable location on the aircraft 10, and may include any suitable number of ailerons, airbrakes, elevators, flaps, flaperons, rudders, spoilers, spoilerons, stabilators, trim tabs, and the like. The aircraft 10 also includes one or more FIR, for example a flight data recorder and a cockpit voice recorder. The flight data recorder is configured for preserving instrumentation and flight parameters, such as velocity, acceleration, heading, roll, altitude, and the like. The cockpit voice recorder preserves recordings of communications between crew members, for example between the pilot and the co-pilot. The FIR operate in an infinite loop, which is to say that the oldest currently stored data is continuously replaced with the most recently acquired data. In the case of an unplanned in-flight event, power to the FIR should be removed, in order to prevent pre-incident data from being overwritten by post-incident data.

In addition, the aircraft 10 may be equipped with any suitable number of control systems. For example, the aircraft 10 has an avionics system and an electrical system. The avionics system can include any number of sensors and control systems for managing the trajectory and operation of the aircraft 10. The electrical system can include power generation and transformation systems, including for powering the avionics systems and one or more FIR of the aircraft 10.

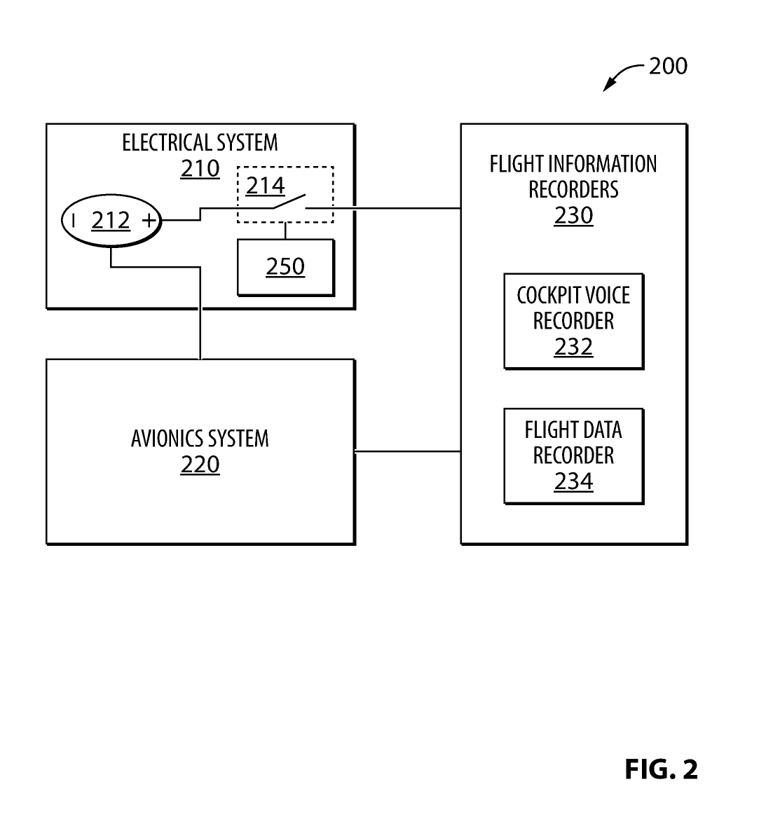

With reference to FIG. 2, the aircraft 10 has a flight information recorder system 200 which includes an electrical system 210, an avionics system 220, and one or more FIR 230. The electrical system 210 has one or more power sources 212 and a switch 214. The power sources 212 provide power to the avionics system 220 and the FIR 230. In some embodiments, the power sources include a 28V DC power supply, or a 115V AC power supply. The switch 214 is located inside the electrical system, in an electrical path which provides electrical power to the FIR 230 from the electrical system 210, and can be any suitable kind of switch. For example, the switch 214 can be a semiconductor switch, a mechanical switch, an electrical relay, and the like. The avionics system 220 includes various sensors for collecting flight-related information, some of which is provided to the FIR 230 for recording. The FIR 230 can include, for example, a flight data recorder 232, a cockpit voice recorder 234, and any other suitable recording devices. The flight data recorder 232 can receive flight-related information from, for example, the avionics system 220, and the cockpit voice recorder 234 can receive audio data from one or more communications systems (not illustrated). The avionics system 220 is configured for implementing start/stop logic for the FIR 230 which governs the operation of the FIR 230 under normal operation. For example, avionics system 220 is configured to send a start or stop command to a dedicated record inhibit input of the FIR 230.

In addition, the electrical system 210 includes a power control module 250 which is configured for controlling operation of the switch 214. The power control module 250 can, under certain circumstances, implement emergency stop logic to remove power from the FIR 230, for example in the case of an unplanned in-flight event.

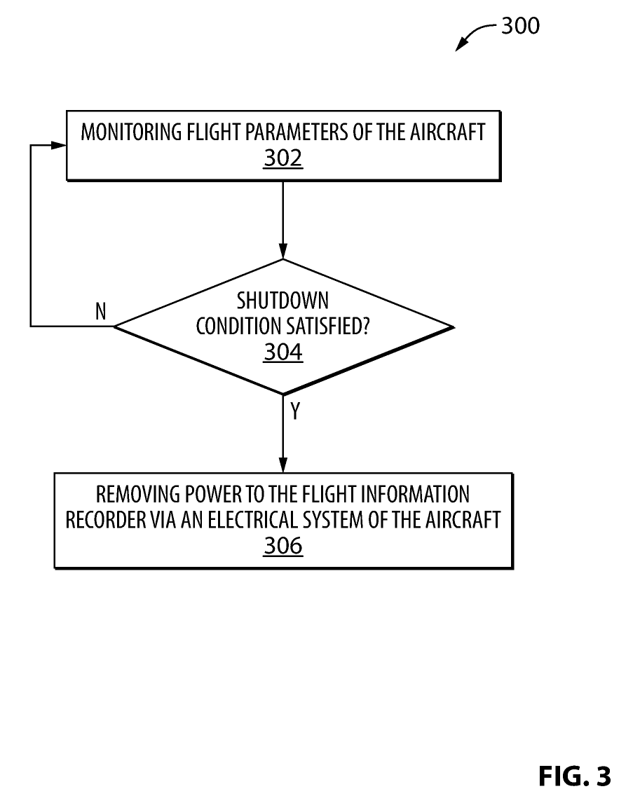

With reference to FIG. 3, the power control module 250 is configured for implementing the emergency stop logic by way of a method 300 for controlling operation of a flight information recorder of an aircraft, such as the FIR 230 of the aircraft 10. The FIR 230 can be a single FIR or any suitable number of FIR, the operation of which can be controlled by the power control module 250.

At step 302, flight parameters of the aircraft are monitored. The flight parameters include a speed parameter, an engine operation parameter, an in-air parameter, and a descent parameter of the aircraft 10. The flight parameters can be monitored in any suitable way using any suitable means. For example, the flight parameters are monitored by one or more sensors. In some embodiments, the flight parameters, namely aircraft speed, engine operation level, whether the aircraft 10 is airborne, and the descent parameter can be obtained through the electrical system 210, the avionics system 220, and/or a flight control system of the aircraft 10. In some embodiments, the monitoring may be performed periodically or continuously. Data about the flight parameters can be pushed by the sensors, or may be pulled by the power control module 250, for example by polling the sensors. In some further embodiments, the sensors or other logic components only provide data to indicate that the flight parameters satisfy certain predetermined thresholds or conditions.

The speed parameter monitored at step 302 can be based on any suitable speed measurement, and can be monitored in any suitable way. The speed parameter may be measured in terms of airspeed, ground speed, global positioning system (GPS) based speed, and the like, or any combination thereof. For example, in the case of an unplanned in-flight event, the speed of the aircraft registers as zero (0). Thus, the speed parameter is monitored to determine whether the speed is at or about 0. The speed parameter can be monitored in any other suitable way, for example for a negative speed, or a speed having a value below or at any suitable threshold. In certain embodiments, a speed condition associated with the speed parameter is satisfied when the value of the speed of the aircraft is below or at a predetermined speed threshold.

The engine operation parameter monitored at step 302 can be based on any suitable indication of the state of operation of one or more engines of the aircraft 10. The engine operation parameter can be monitored in terms of any engine operation parameter, for example an engine oil pressure, a count of fan or turbine rotations-per-minute, a level of fuel flow to the engine, and the like. For example, in the case of an unplanned in-flight event, the engine oil pressure may drop below a given threshold, the fan or turbine may stop rotating, and fuel flow to the engine may drop below a given threshold. Thus, the engine operation parameter is monitored to determine a value representative of a level of operation of the engines of the aircraft 10 relative to a predetermined engine operating threshold. In some embodiments, the engine operation parameter is one or more values based on a plurality of levels of operation of the engines of the aircraft 10. For example, the engine operation parameter can be based on both a number of rotations per minute and an engine oil pressure. In certain embodiments, an engine operation condition associated with the engine operation parameter is satisfied when one or more engine operation parameters have values that are below or at respective predetermined operating thresholds.

The in-air parameter monitored at step 302 can be based on any suitable indication of whether the aircraft 10 is airborne. The in-air parameter can be monitored in terms of the presence or absence of weight on one or more wheels of the aircraft 10 or by way of an altitude of the aircraft 10. The presence or absence of weight on the wheels of the aircraft 10 can be monitored by way of a sensor near or on the wheels of the aircraft 10, or near or on a suspension system associated with the wheels of the aircraft 10. The altitude of the aircraft 10 can be monitored in any suitable way, for example via GPS, ground-based RADAR, and the like. For example, in the case of an unplanned in-flight event, no weight is present on the wheels, and a weight-on-wheels parameter is false. In another example, in the case of an unplanned in-flight event, the altitude of the aircraft 10 may be below a certain threshold, such as under 10,000 feet (or 3,000 meters). In cases where the aircraft 10 is upside down during an unplanned in-flight event, the altitude may register as a negative, and instead the absolute value of altitude of the aircraft 10 can be monitored as the in-air parameter. Thus, the in-air parameter is a value representative of whether the aircraft 10 is airborne. In some embodiments, the in-air parameter can be a value based on both the altitude and the presence of weight on the wheels of the aircraft 10. In certain embodiments, an in-air condition associated with the in-air parameter is satisfied when the altitude of the aircraft is below or at a predetermined threshold, or when there is an absence of weight on the wheels of the aircraft.

In some embodiments, the descent parameter monitored at step 302 is based on a vertical descent parameter indicative of whether the aircraft 10 has completed a vertical descent. In some embodiments, the descent parameter is a value representative of an altitude rate-of-change. For example, if the altitude of the aircraft decreases at a rate above a predetermined threshold and then stops decreasing, the aircraft 10 is considered to have completed a vertical descent, and the descent parameter can be assigned a predetermined value. For example, the descent parameter can be assigned a ‘TRUE’ value, a value of ‘1’, or any other suitable value. In some other embodiments, the descent parameter is based on an inertial vertical speed, and if the inertial vertical speed is above a predetermined threshold and then is reduced to 0, the aircraft 10 is considered to have completed a vertical descent, and the descent parameter can be assigned the predetermined value. Still other descent parameters are considered. In certain embodiments, a descent condition associated with the descent parameter can be satisfied when a vertical descent has been completed by the aircraft 10.

In other embodiments, the descent parameter monitored at step 302 is based on a descent delay. The descent delay can begin from a moment when values of the remaining flight parameters match certain predetermined thresholds or limits. For example, the descent delay can commence once the aforementioned speed, engine operation, and in-air conditions are satisfied. In some embodiments, the descent delay is based on a predetermined time delay associated with a time duration, or portion thereof, considered to be required for an aircraft to reach the ground after an unplanned in-flight event has been determined via the values of the remaining flight parameters matching certain predetermined limits or thresholds (such as 0 air speed, no engine oil pressure and weight-off-wheels). The descent delay may also be based on a maximum time duration required for an aircraft 10 to reach the ground after an unplanned in-flight event experienced at a cruising altitude. For example, the maximum time duration may be 5 minutes, and the descent delay may be double that, thus 10 minutes. In other embodiments, the descent delay is based on any other suitable time value. In certain embodiments, the aforementioned descent condition can be satisfied when a descent delay has elapsed following the remaining flight parameters matching certain predetermined thresholds or limits.

In some embodiments, each of the flight parameters is monitored independently of one another. In other embodiments, all of the flight parameters are monitored substantially simultaneously. In further embodiments, the flight parameters are monitored in a particular sequence. For example, the speed, engine operation, and in-air parameters are monitored together, and once these three parameters have values which match predetermined thresholds or limits, monitoring of the descent parameter begins. Thus, in some embodiments, the descent parameter acts as a failsafe for the speed, engine operation, and in-air parameters. For example, in embodiments where the descent parameter is based on a descent delay, the descent parameter may act as a countdown from a time when the speed, engine operation, and in-air parameters have values which match the aforementioned predetermined thresholds or limits. When the countdown elapses, the descent condition associated with the descent parameter is considered to be satisfied.

The descent parameter is monitored at least in part to avoid a situation where power to the FIR 230 is pre-emptively cut prior to the end of an unplanned in-flight event. For example, in a deep stall it is possible that the aircraft 10 registers a speed 0 while the engines are stalled or off, and with no weight-on-wheels. Despite three of the flight parameters having values indicative of an unplanned in-flight event having taken place, the unplanned in-flight event is still ongoing. Thus, the descent parameter is monitored to determine when the vertical descent is completed and/or to determine when the descent delay has elapsed.

At step 304, a decision is made regarding whether a shutdown condition associated with the flight parameters is satisfied. The shutdown condition is based on the values of the flight parameters in relation to one or more thresholds or limits. For example, the shutdown condition is satisfied when each of the aforementioned conditions associated with the flight parameters are satisfied. Thus, the shutdown condition is satisfied if the value of the speed parameter is below or at a predetermined threshold, if the value of the engine operation parameter is below or at a predetermined operating threshold, if the value of the altitude of the aircraft is below or at a predetermined threshold, or when there is an absence of weight on the wheels of the aircraft 10, and if a vertical descent has been completed by the aircraft 10 or if a descent delay has elapsed. In short, the shutdown condition can be satisfied when values of the flight parameters meet the predetermined thresholds or limits. In certain embodiments, the shutdown condition is based on multiple metrics for each flight parameter. For example, the shutdown condition is based on both an altitude of the aircraft 10 and an absence of weight on the wheels of the aircraft 10, both of which are embodiments of the in-air parameter.

If the shutdown condition is not satisfied, the method returns to step 302. In some embodiments, the shutdown condition must be satisfied for a predetermined length of time, such as a few seconds or a few minutes. If the shutdown condition is satisfied, the method 300 proceeds to step 306

At step 306, power to the FIR 230 is removed via the electrical system 210 of the aircraft 10, and more specifically the switch 214. This causes the FIR 230 to stop the infinite loop of recording flight information, thus preserving the information is stored within the FIR 230.

Thus, the method 300 ensures that the FIR 230 are only stopped after the occurrence of an unplanned in-flight event. For example, if the in-air parameter is not monitored, the electrical power could be removed from the FIR 230 for a parked aircraft. Similarly, if the descent parameter relating to the vertical descent and/or descent delay parameter is not monitored, electrical power could be removed from the FIR 230 for a plane still experiencing an unplanned in-flight event. It should be noted that the flight parameters may be monitored sequentially or in parallel. In either case, step 304 will lead to removing power to the FIR 230 at step 306 only when the shutdown condition is satisfied.

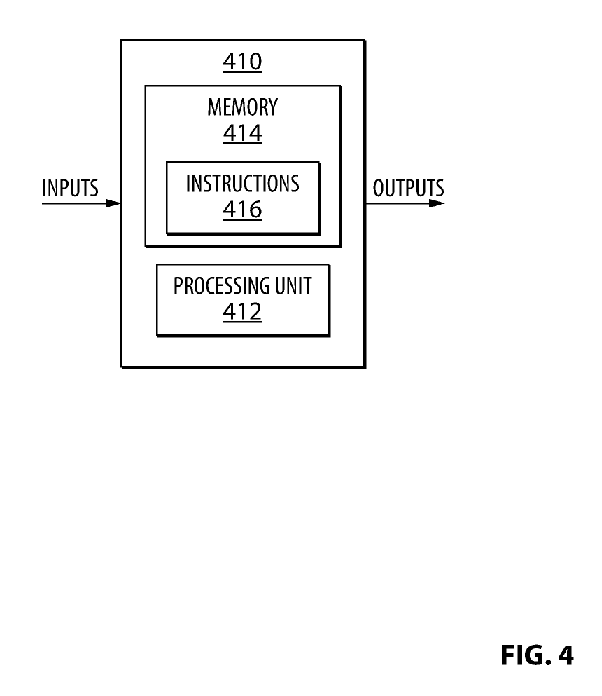

With reference to FIG. 4, the method 300 may be implemented by a computing device 410, comprising a processing unit 412 and a memory 414 which has stored therein computer-executable instructions 416. The processing unit 412 may comprise any suitable devices configured to cause a series of steps to be performed so as to implement the method 300 such that instructions 416, when executed by the computing device 410 or other programmable apparatus, may cause the functions/acts/steps specified in the methods described herein to be executed. The processing unit 412 may comprise, for example, any type of general-purpose microprocessor or microcontroller, a digital signal processing (DSP) processor, a central processing unit (CPU), an integrated circuit, a field programmable gate array (FPGA), a reconfigurable processor, other suitably programmed or programmable logic circuits, or any combination thereof.

The memory 414 may comprise any suitable known or other machine-readable storage medium. The memory 414 may comprise non-transitory computer readable storage medium such as, for example, but not limited to, an electronic, magnetic, optical, electromagnetic, infrared, or semiconductor system, apparatus, or device, or any suitable combination of the foregoing. The memory 414 may include a suitable combination of any type of computer memory that is located either internally or externally to device such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like. Memory may comprise any storage means (e.g., devices) suitable for retrievably storing machine-readable instructions executable by processing unit.

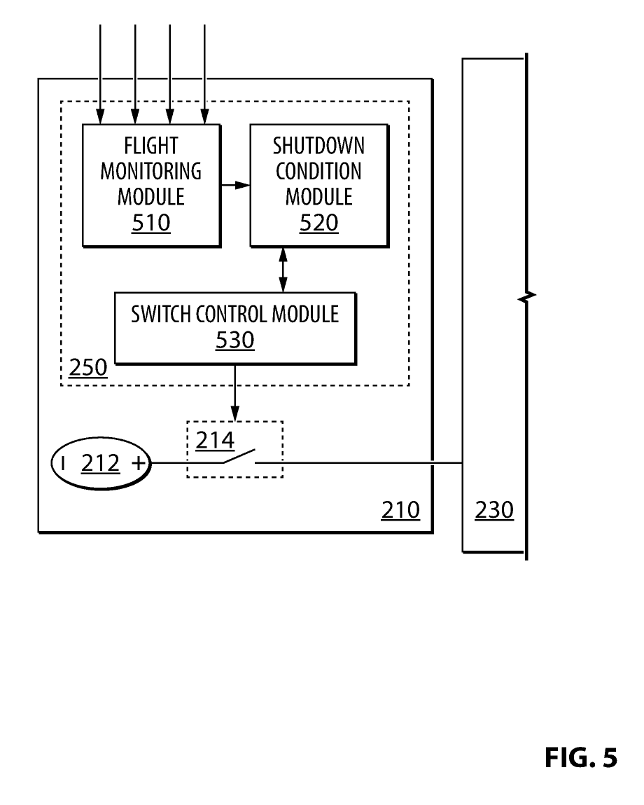

With reference to FIG. 5, an example computer-based implementation of the power control module 250 which implements the emergency stop logic by way of the method 300 is illustrated. The power control module 250 is configured to control the switch 214, which is located in the electrical path that provides electrical power to the FIR 230 from the electrical system 210. As discussed hereinabove, the switch 214 can be any suitable kind of switch. The power control module 250 includes a flight monitoring module 510, a shutdown condition module 520, and a switch control module 530.

The flight monitoring module 510 is configured for receiving information about the aircraft 10 indicative of a speed of the aircraft 10, a level of operation of the engine, whether the aircraft 10 is airborne, whether the aircraft 10 has completed a vertical descent and/or whether a descent delay has elapsed. Thus, the flight monitoring module 510 is configured for monitoring the flight parameters of the aircraft 10, as per step 302. For example, the information can be received from one or more sensors located on the aircraft 10. In some embodiments, the flight monitoring module 510 receives raw information, such as an airspeed, a fuel flow rate, an altitude, and a vertical descent rate. The flight monitoring module 510 may then process the raw information to determine values for the flight parameters. In some embodiments, the flight monitoring module 510 also receives ‘TRUE’ or ‘FALSE’ indications as to whether the flight conditions associated with the flight parameters are satisfied. For example, the flight monitoring module 510 can receive a ‘true’ indication if the aircraft speed is 0.

In certain embodiments, the flight monitoring module 510 provides the flight parameters to the shutdown condition module 520. The flight parameters can be provided in any suitable format and/or using any suitable data type. In other embodiments, the flight monitoring module 510 provides an indication to the shutdown condition module 520 when all the flight conditions associated with the flight parameters are satisfied.

The shutdown condition module 520 is configured for determining whether a shutdown condition is satisfied, as per step 304. In some embodiments, the shutdown condition module 520 receives the flight parameters from the flight monitoring module 510 and determines, based on the flight parameters, whether the shutdown condition is satisfied. In other embodiments, the shutdown condition module receives an indication of the flight conditions associated with the flight parameters being satisfied, and upon receiving the indication determines that the shutdown condition is satisfied. If the shutdown condition is satisfied, the shutdown condition module 520 sends an indication to the switch control module 530 to inform the switch control module 530 that the shutdown condition is satisfied.

In certain embodiments, the flight monitoring module 510 is configured to monitor the speed, engine operation, and in-air parameters, and the shutdown condition module 520 is configured for monitoring the descent parameter. For example, the shutdown condition module 520 can receive the descent parameter from the flight monitoring module 510 or from any other suitable source. In another example, the descent parameter is a descent delay, and the shutdown condition module 520 can begin a countdown on the descent delay when the flight conditions associated with the speed, engine operation, and in-air parameters are satisfied. Thus, in some embodiments, the shutdown condition module 520 monitors the descent parameter only after receiving an indication from the flight condition module 510 that the speed, engine operation, and in-air conditions are satisfied. In some other embodiments, the shutdown condition module 520 continuously or periodically monitors the descent parameter independent of the flight condition module 510.

The switch control module 530 is configured for removing power to the FIR 230, as per step 306, via the switch 214. The switch control module 530 is configured for receiving, from the shutdown condition module 520, an indication that the shutdown condition is satisfied. When the shutdown condition is satisfied, the switch control module 530 actuates the switch 214 to open the electrical path which provides electrical power from the power sources 212. This removes the electrical power from the FIR 230, which stop their operation. This prevents any post-incident information from being recorded, and preserves the pre-incident information already stored on the FIR 230.

The methods and systems for controlling operation of a flight information recorder of an aircraft, such as the FIR 230 of the aircraft 10, described herein may be implemented in a high level procedural or object oriented programming or scripting language, or a combination thereof, to communicate with or assist in the operation of a computer system, for example the computing device 410. Alternatively, the methods and systems for controlling operation of a flight information recorder of an aircraft described herein may be implemented in assembly or machine language. The language may be a compiled or interpreted language. Program code for implementing the methods and circuits for controlling the operation of an aircraft described herein may be stored on a storage media or a device, for example a ROM, a magnetic disk, an optical disc, a flash drive, or any other suitable storage media or device. The program code may be readable by a general or special-purpose programmable computer for configuring and operating the computer when the storage media or device is read by the computer to perform the procedures described herein. Embodiments of the methods and circuits for controlling operation of a flight information recorder of an aircraft described herein may also be considered to be implemented by way of a non-transitory computer-readable storage medium having a computer program stored thereon. The computer program may comprise computer-readable instructions which cause a computer, or more specifically the at least one processing unit of the computer, to operate in a specific and predefined manner to perform the functions described herein.

Computer-executable instructions may be in many forms, including program modules, executed by one or more computers or other devices. Generally, program modules include routines, programs, objects, components, data structures, etc., that perform particular tasks or implement particular abstract data types. Typically the functionality of the program modules may be combined or distributed as desired in various embodiments.

Various aspects of the methods and systems for controlling operation of a flight information recorder of an aircraft disclosed herein may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments. Although particular embodiments have been shown and described, it will be obvious to those skilled in the art that changes and modifications may be made without departing from this invention in its broader aspects. The scope of the following claims should not be limited by the preferred embodiments set forth in the examples, but should be given the broadest reasonable interpretation consistent with the description as a whole.

1. A method for controlling operation of a flight information recorder of an aircraft, comprising:
monitoring flight parameters of the aircraft, the flight parameters comprising:
a speed parameter;
an engine operation parameter;
an in-air parameter; and
a descent parameter comprising a descent delay; and
when a shutdown condition, associated with the flight parameters and associated at least in part with the descent delay elapsing, is satisfied, removing power to the flight information recorder via an electrical system of the aircraft.

2. (canceled)

3. (canceled)

4. The method of claim 1, wherein monitoring the flight parameters comprises monitoring all the flight parameters substantially simultaneously.

5. The method of claim 1, wherein monitoring the flight parameters comprises monitoring the descent parameter separately from the speed, engine operation, and in-air parameters.

6. The method of claim 5, wherein monitoring the flight parameters comprises monitoring the descent parameter upon determination that the speed, engine operation and in-air parameters have satisfied predetermined thresholds.

7. The method of claim 1, wherein monitoring the speed parameter comprises monitoring at least one of an airspeed, a ground speed, and global-positioning-system-based speed of the aircraft.

8. The method of claim 1, wherein monitoring the engine operation parameter comprises monitoring at least one of engine oil pressure, engine fuel flow, turbine rotations-per-minute, and fan rotations-per-minute.

9. The method of claim 1, wherein monitoring the in-air parameter comprises monitoring at least one of a weight-off-wheels parameter and a weight-on-wheels parameter.

10. The method of claim 1, wherein monitoring the in-air parameter comprises monitoring an altitude of the aircraft.

11. The method of claim 1, wherein monitoring the flight parameters comprises obtaining the flight parameters through the electrical system of the aircraft.

12. A system for controlling operation of a flight information recorder powered by an electrical system of an aircraft, the system comprising:
a processing unit; and
a non-transitory memory communicatively coupled to the processing unit and comprising computer-readable program instructions executable by the processing unit for:
monitoring flight parameters of the aircraft, the flight parameters comprising:
a speed parameter;
an engine operation parameter;
an in-air parameter; and
a descent parameter comprising a descent delay; and
when a shutdown condition, associated with the flight conditions and associated at least in part with the descent delay elapsing, is satisfied, removing power to the flight information recorder via the electrical system.

13. (canceled)

14. (canceled)

15. The system of claim 12, wherein monitoring the flight parameters comprises monitoring all the flight parameters substantially simultaneously.

16. The system of claim 12, wherein monitoring the flight parameters comprises monitoring the descent parameter separately from the speed, engine operation, and in-air parameters.

17. The method of claim 16, wherein monitoring the flight parameters comprises monitoring the descent parameter upon determination that the speed, engine operation and in-air parameters have satisfied predetermined thresholds

18. The system of claim 12, wherein monitoring the speed parameter comprises monitoring at least one of an airspeed, a ground speed, and global-positioning-system-based speed of the aircraft.

19. The system of claim 12, wherein monitoring the engine operation parameter comprises monitoring at least one of engine oil pressure, engine fuel flow, turbine rotations-per-minute, and fan rotations-per-minute.

20. The system of claim 12, wherein monitoring the in-air parameter comprises monitoring at least one of a weight-off-wheels parameter and a weight-on-wheels parameter.

21. The system of claim 12, wherein monitoring the in-air parameter comprises monitoring an altitude of the aircraft.

22. The system of claim 12, wherein monitoring the flight parameters comprises obtaining the flight parameters through the electrical system of the aircraft.

23.-35. (canceled)
